(19) United States
(12) Patent Application Publication
(10) Pub. No.: US 2023/0145461 A1
(43) Pub. Date: May 11, 2023

(54) RECEIVING AND INTEGRATING EXTERNAL DATA INTO A GRAPHICAL USER INTERFACE OF AN ISSUE TRACKING SYSTEM

(71) Applicants: Atlassian Pty Ltd., Sydney (AU); Atlassian Inc., San Francisco, CA (US)

(72) Inventors: Bruce Templeton, Sydney (AU); Daniel Hocking, Kingsford (AU); David Mo, Sydney (AU); Dmitry Pak, Sydney (AU); Gustavo Maciel, Sydney (AU); Karina Moraes da Silva, Sydney (AU); Rodrigo Berto, Sydney (AU); Taylor Pechacek, Sydney (AU); Terry Agapitos, Sydney (AU)

(21) Appl. No.: 17/565,613

(22) Filed: Dec. 30, 2021

Related U.S. Application Data
(60) Provisional application No. 63/276,519, filed on Nov. 5, 2021.

(51) Int. Cl. G06Q 10/06; G06F 11/36

(52) U.S. Cl. CPC G06Q 10/063114; G06F 11/3664

(57) ABSTRACT

A method including receiving, at an issue tracking system, an application programming interface (API) call identifying an issue being tracked using the issue tracking system. The method includes authenticating a source of the API call extracted from data included in the API call, and assessing a permissions level associated with the authenticated source of the API call for updating the issue in the issue tracking system. The method includes determining a category of an object of an application different from an issue tracking system, and based on the determined category of the object, displaying a portion of information related to the issue that is updated according to at least one attribute of the object in the issue GUI.

### CROSS-REFERENCE TO RELATED APPLICATION(S)

This application is a nonprovisional patent application of and claims the benefit of U.S. Provisional Patent Application No. 63/276,519, filed Nov. 5, 2021 and titled “Receiving and Integrating External Data Into a Graphical User Interface of an Issue Tracking System,” the disclosure of which is hereby incorporated herein by reference in its entirety.

### TECHNICAL FIELD

Embodiments described herein relate to data storage and presentation in an issue tracking system and, in particular to systems and methods for integrating external data into a graphical user interface of an issue tracking system.

### BACKGROUND

An organization may require employees to use an internal collaborative software environment to complete work related to common goals. A collaborative software environment may include one or more discrete services that can be leveraged by the team to improve efficiency, such as an issue tracking service, a messaging service, a project management service, and the like. In addition to internal tools, the organization may provide employees with secure access to one or more third-party tools, such as a document storage service, a videoconferencing service, and the like.

In many cases, however, regularly interacting with multiple internal and/or external discrete services of a collaborative software environment may be time and/or resource consuming for individual developers, reducing team productivity and reducing usefulness of the collaborative software environment.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A depicts a networked computing environment in or over which embodiments as described herein may be implemented.

FIG. 1B depicts a simplified system diagram of an issue tracking system, as described herein.

FIG. 2 depicts an example graphical user interface (GUI) of an issue tracking system, as described herein.

FIG. 3 is another example screen of the GUI of FIG. 2 in accordance with some embodiments.

FIG. 4 is an example screen of a GUI in accordance with some embodiments.

FIG. 5 is a block diagram of a computerized system implementing various embodiments of the present disclosure.

FIG. 6 is a flow chart that describes method steps in accordance with some embodiments.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for receiving and presenting data from an external system into an issue tracking system. As a result of the systems and methods described herein, a user or team of users of an issue tracking system can consume information related to a particular issue tracked by the issue tracking system from an arbitrary number of first or third party sources in a single, unified user interface, namely from within a frontend graphical user interface of the issue tracking system itself.

More broadly, the embodiments described herein relate to methods of aggregating information relevant to a particular issue in an issue tracking system at a particular time. As a result of the constructions described herein, an issue tracked by an issue tracking system can be hydrated/enriched by information from multiple external sources, thereby presenting for a developer viewing the issue all or substantially all issue-relevant information. In some cases, this information may be or may include information of particular interest to an assignee of the issue, such as a status of some remote process (e.g., a static analysis operation over a code repository). In other cases, this information may be or may include information that a supervisor of an assignee of the issue wants to ensure that the assignee considers before modifying or closing the issue, such as the status of another issue tracked by the issue tracking system (e.g., in another project). In yet other cases, the information can include schedule or calendar information, such as a reminder that a team member is resident in another time zone, and it may be more appropriate to modify the issue at a different time, or under different circumstances. These examples are not exhaustive; many further examples are described herein.

For example, an issue tracking system may be used by a team of software developers to track work items related to maintaining and improving a particular software product. Individual issue reports may be opened that each uniquely describe an issue, feature request, or other task related to the software product. As the team of software developers addresses bugs and improves the software product, individual issue reports may be closed. As issue reports are closed, developer attention can be reallocated to other open issue reports, and the active development cycle can continue.

In some cases, however, other tools—separate from the issue tracking system—may be used by the same team of developers. In many cases, these other tools may store or otherwise control access to information or data relevant to a particular open issue report (also referred to as a “ticket”).

For example, in some cases, a code repository service internal or external to the organization may include one or more static analysis tools or security analysis tools that periodically provide output (within the code repository system) relating to results of a security analysis and/or a static analysis operation. For example, the analysis tools may be configured to output a status of “pass” or “fail” indicating whether a particular portion of code, such as a file, a code snippet, a pull request, framework, dependency, and so on has passed or failed one or more tests executed by that tool. Pass or failure of a particular test may be required—as a matter of organization policy—before a corresponding issue in the issue reporting system may be cleared.

For example, a team of developers may maintain an email client application. The team may store code defining the email client application in a code repository managed by a code repository service. The team may track issues/tickets relating to the email client application in an issue tracking system.

Once a member of the team becomes aware of a bug in the email client application, a new ticket may be added to the issue tracking system describing the issue, steps to reproduce the issue, and so on. The ticket may be assigned to a particular developer to address. Once the ticket is assigned to the developer, the developer may review relevant portions of code in a local or master branch of the code repository to determine a root cause of the problem that triggered the ticket. Once the developer understands the root cause, the developer can fix the problem in a local branch and submit a pull request to the code repository system.

In many development teams, a pull request may trigger a workflow in which a supervisor of the developer is required to review the developer's code prior to merging the pull request into the master branch. In addition, in some cases, a security analysis of the pull request (and/or any modified files, changed dependencies, upstream files, downstream files, and so on) may also be required.

In further examples, the pull request may be required to undergo and pass a static analysis test and/or one or more unit tests to verify, as one example, interoperability with other existing functionality of the email client application and/or to verify that the pull request complies with style guidelines and other organization-endorsed requirements and best practices. Each of these example requirements is subsequent to the developer submitting the pull request, and may be required prior to the developer closing the corresponding ticket in the issue tracking system.

More generally and broadly, in many development teams, bug reports, tickets, and/or issues opened as issue reports in an issue tracking system may only be closed after a pull request purporting to fix an identified bug has passed one or more various tests and review operations required by an organization. Example tests that may be required include but are not limited to: unit tests; dependency traversals; security analyses; test queries; QA testing; code review; static analysis operations; dynamic/compile-time operations; and so on.

In conventional systems, a developer is required to context switch between multiple tools in order to close one or more tickets. For example, the developer in the preceding example is required to access the code repository system in order to verify whether the pull request submitted by that developer has passed all requisite tests.

In yet other examples, other third party tools may be required and/or implicated when a user of an issue tracking system attempts to change or update information related to a particular ticket. For example, in some cases, an individual tasked with updating an assignee of a ticket may be required to check a project management application to determine whether a potential new assignee has time to address the ticket. In other cases, an individual tasked with closing a ticket may require manager approval, which may require context switching to an email application. In other cases, an individual tasked with closing a ticket may be required to context switch to a documentation service to review a checklist of items required by policy to be completed prior to closing the ticket.

Generally and broadly, it may be appreciated that users of an issue tracking system are often required to context switch to other applications, services, platforms, and systems—whether first party or third party—in order to collect all information, and complete all steps, necessary to effectively manage information contained, presented, and stored within the issue tracking system itself (e.g., information necessary to change status, information necessary to close a ticket, information necessary to update ticket information, and so on). As noted above, regular context switching reduces efficiency and increases the time required to open and close tickets. For software development teams, context switching increases the time required to fix bugs and push updates and changes to production environments (e.g., to end-users).

Accordingly, embodiments described herein relate to systems and methods for operating an issue tracking system to receive external data as input such that the external data can be displayed within a common graphical user interface with individual tickets tracked by the issue tracking system. As a result of the systems and methods described herein, a user of the issue tracking system can quickly and easily determine whether all steps/operations necessary to close a ticket or perform another task with the ticket are conveniently presented within the ticket itself; context switching delays are substantially eliminated.

For example, an issue tracking system as described herein can include a backend and a frontend. The frontend can be configured to operate as an instance of software (a “client application”) executing on a client device and the backend can be configured to operate as an instance of software (a “backend application”) executing over a processor allocation and memory allocation of a cloud computing platform, which may include one or more physical or virtual host servers. The frontend application and the backend application can be configured to communicate over one or more networks, including private and public networks, to exchange information related to the issue tracking system and issues tracked therein. For example, a user device such as a laptop can be configured to leverage a processor and memory thereof to instantiate an instance of the frontend application, which in turn leverages a display of the laptop to render a graphical user interface for the issue tracking system to the user. In some cases, the frontend application may be configured to operate in a browser of the laptop, although this is not required of all embodiments. In other cases, the frontend application may be a native application.

The user of the laptop can operate the graphical user interface of the frontend application to access information, such as issues/tickets, stored by the backend application. More particularly inputs received by the graphical user interface of the frontend application can cause the frontend application to generate one or more requests to one or more application programming interfaces (APIs) of the backend application. In response to the requests, the backend application can provide data in a structured form to the frontend application to display to the user via the graphical user interface.

In these examples, as noted above, the frontend application and/or the backend application can be further configured to receive input from an arbitrary number of third-party or first-party services. An attribute or property or portion of the input can be processed so as to associate the input with one or more tickets tracked by the issue tracking system. Once associated with one or more tickets (which may be tickets related by dependency, within a project, associated by common assignee or other property, or any other relation or in further cases, a set of unrelated tickets) other attributes, properties, or portions of the input can be parsed to generate one or more graphical user interface elements to be displayed within the graphical user interface of the frontend application whenever the associated tickets are also displayed.

For example, a team of developers may maintain an image processing application. As with other examples described herein, the team may store code defining the image processing application in a code repository managed by a code repository service and the team may track issues/tickets relating to the image processing application in an issue tracking system.

As with other examples described herein, once a member of the team becomes aware of a bug in the image processing application, a new ticket with identifier 1235 may be added to the issue tracking system as issue report 1235 describing the issue, steps to reproduce the issue, and so on. The ticket may be assigned to a particular developer to address. Once the ticket is assigned to the developer, the developer may review relevant portions of code in a local or master branch of the code repository to determine a root cause of the problem that triggered the ticket. Once the developer understands the root cause, the developer can fix the problem in a local branch and submit a pull request to the code repository system.

In this example, however, the code repository system can be configured to generate an output to be received as input to the issue tracking system when each required security or analysis test for the image processing application is passed. For example, the code repository system can be configured to submit an HTTP request, such as GET or POST request to the issue tracking system including in a header or body thereof structured data such as:

```
{
  issue_report_id : 1235,
  issue_report_project_id: 4567,
  input_type: status,
  input_value: PENDING,
  input_title: “Static Analysis”,
  callback_url: “https://sub.domain.tld/api/v1/callback”,
  auth_token: xSB2TZZU1HC1mThV9wrsJoYueYcZO9rV,
  role_token: MEmHFIb7KI6blfT0kGDZdF6rU26POyvN,
  user_token: IRibVwop8PzQDfUybp3gXkqktSekv14S
}
```

In this example, the code repository submits an open loop (or closed loop) request to the issue tracking system that identifies a particular issue report (e.g., issue_report_id), a parent project of the issue report, optionally (e.g., issue_report_project_id), and provides structured data input including a type of input, a value for the input type, a title associated with the input value, a callback URL that may be leveraged by the issue tracking system to provide further outputs to the code repository system, and one or more authentication tokens which may be user-specific (e.g., specific to a particular user of the issue tracking system and/or the code repository system), role specific (e.g., specific to a particular role within the issue tracking system and/or the code repository system) and/or platform specific (e.g., affording permissions to the code repository system to provide input to the issue tracking system).

Upon receiving this input from the code repository system, the issue tracking system can change the manner in which a graphical user interface displays information related to issue report 1235 and/or all issue reports in project 4567. For example, the issue tracking system can cause to be generated a visual indication of pendency near a graphical user interface element displaying the text “Static Analysis.” The visual indication of completeness may be a ellipse, a green colored box, or any other suitable visual indication.

Once an associated static analysis operation has been completed by the code repository system, the code repository system can once again submit an HTTP request, such as GET or POST request to the issue tracking system including in a header or body thereof structured data such as:

```
{
  issue_report_id : 1235,
  issue_report_project_id: 4567,
  input_type: status,
  input_value: PASS,
  input_title: “Static Analysis”,
  callback_url: “https://sub.domain.tld/api/v1/callback”,
  auth_token: xSB2TZZU1HC1mThV9wrsJoYueYcZO9rV,
  role_token: MEmHFIb7KI6blfT0kGDZdF6rU26POyvN,
  user_token: IRibVwop8PzQDfUybp3gXkqktSekv14S
}
```

Upon receiving this input, the issue tracking system can cause to be generated a visual indication of completeness near a graphical user interface element displaying the text “Static Analysis.” The visual indication of completeness may be a checkmark, a green colored box, or any other suitable visual indication.

In some cases, the static analysis operation may fail. In these examples, once the associated static analysis operation has been completed by the code repository system, the code repository system can again submit an HTTP request, such as GET or POST request to the issue tracking system including in a header or body thereof structured data such as:

```
{
  issue_report_id : 1235,
  issue_report_project_id: 4567,
  input_type: status,
  input_value: FAIL,
  input_title: “Static Analysis”,
  callback_url: “https://sub.domain.tld/api/v1/callback”,
  auth_token: xSB2TZZU1HC1mThV9wrsJoYueYcZO9rV,
  role_token: MEmHFIb7KI6blfT0kGDZdF6rU26POyvN,
  user_token: IRibVwop8PzQDfUybp3gXkqktSekv14S,
  tenant_token: eyJhbGciOiJIUzI1NiIsInR5cCI6IkpXVCJ9,
  session_token: SflKxwRJSMeKKF2QT4fwpMeJf36POk6yJV
}
```

Upon receiving this input, as with previously described received inputs, the issue tracking system can cause to be generated a visual indication of failure near a graphical user interface element displaying the text “Static Analysis.” The visual indication of completeness may be a cross mark, a red colored box, or any other suitable visual indication.

As a result of this construction, every time the developer referenced above opens the issue tracking system to determine whether ticket 1235 can be closed, the developer can be immediately presented with a visual indication corresponding to the status of the static analysis operation(s) conducted by—and required to be conducted by—the code repository system. In this manner, as may be readily appreciated by a person of skill in the art, the developer is not required to context switch away from the issue tracking system to determine the status of the static analysis operation.

In some cases, more than one issue report can be updated and/or modified in response to a single input such as described above. For example, in some examples, all or some issue reports tagged with the project id 4567 may be updated with a status such as described above. In this manner, multiple tickets that are dependent upon a single static analysis operation can be updated with corresponding visual indications, such as described above.

Further, it may be appreciated that the foregoing example in which JSON-formatted data is submitted to an issue tracking system via an HTTP GET or POST request is not required. For example, in some embodiments, information related to an input such as described herein can be encoded in a URL structure, submitted via a single HTTP GET request to the issue tracking system. For example, the foregoing example input may be URL-encoded as:

https://issue_tracking_system.domain.tld/input?issue_report
_id=1235&issue_report_project_id=4567&input_type=status&inp
ut_value=FAIL&input_title=″Static%20Analysis&callback_url=su
b.domain.tld%2fapi%2fv1%2fcallback&uth_token=xSB2TZZU1H
C1mThV9wrsJoYueYcZO9rV&role_token=MEmHFIb7KI6blfT0
kGDZdF6rU26POyvN&user_token=IRibVwop8PzQDfUybp3gXk
qktSekv14S

These foregoing examples are not exhaustive; it may be appreciated that the code repository system can communicate securely and in an authenticated manner with the issue tracking system (such as described here) in any suitable manner, over any suitable communication protocol or combination of protocols, and so on.

Further, it may be appreciated that any suitable data can be communicated from an external resource to an issue tracking system to display alongside information rendered in a graphical user interface of a frontend application of that issue tracking system in any suitable manner.

For example, in some cases, multiple input/data/status items may be communicated in a single message from an external resource to an issue tracking system. For example, the JSON-formatted static analysis status messages described above may be members of an array of other similar or different messages.

In other cases, as noted above, information different from status of a particular remote process (e.g., unit test, static analysis, security analysis, and so on) can be communicated to an issue tracking system such as described herein. For example, remote metadata can be communicated such as, but not limited to: a last edit date of a particular remote document or file; a link to an email referencing a particular ticket; a callback telephone number of an agent most recently accessing a particular ticket; a current work status of an assignee of a particular ticket (e.g., available, busy, out of office, and so on); a combined status or aggregate status of multiple remote processes; and so on.

In further embodiments, an issue tracking system can be configured to display information in a graphical user interface in a manner different than described above. For example, in addition to and/or in place of a status identifier such as described above, corresponding to status of execution of a remote process, the issue tracking system may be configured to display historical information, recorded by the issue tracking system, regarding a particular status update. For example, the issue tracking system can be configured to display that a static analysis process has been complete/passed for N hours, based on a time difference from a render time of a graphical user interface and a timestamp at which the most recent status message relating to the status analysis process was received.

In other cases, numerical status (e.g., percent complete, number of remaining tasks, and so on) can be plotted over time by the issue tracking system after receiving periodic updates from an external system. In yet other examples, the issue tracking system can be configured to aggregate one or more status items or other data items together into a single graphical user interface element. For example, if a single issue report requires passing of three separate tests (e.g., static analysis, security analysis, and unit test), the issue tracking system can display a status of “INCOMPLETE” or “PENDING” while at least one of the three tests remains pending. In these examples, only after all three tests have completed can the single aggregated status item—shown as a visual indication of status in a graphical user interface of the frontend of the issue tracking system—be updated.

In yet other examples, an issue tracking system as described herein can be configured to receive and present other information unrelated to status. For example, a remote system responsible for documentation may be configured to send a message to the issue tracking system—such as described above—any time a URL to a remote resource (such as a document relevant to a particular issue) updates or changes. As a result of this construction, any time the frontend of the issue tracking system renders information related to a particular issue, external links to information relevant to that issue can be assured to point to fresh information.

For simplicity of description, the embodiments described herein reference an issue tracking system as an example collaboration tool (associated with a “collaborative software environment”) that may be configured to receive information and/or data from an external resource so as to display that data within a graphical user interface of the issue tracking system. However, it may be appreciated that this open-loop architecture can apply equivalently to other collaboration tools and services, any of which can be implemented in whole or in part as software executed by one or more virtual or physical server(s) or other computing appliances or communicably coupled combination of appliances that provides a team of individuals with a centralized or federated system for communicating and exchanging information and maintaining version control over shared source code related to one or more software products.

A collaborative software environment, in many examples, provides or otherwise hosts multiple discrete services that can be independently or collectively leveraged by members of a software development team. For example, a collaborative software environment can include services such as, without limitation: an issue tracking service; a code repository service; a messaging service; a documentation service; a project management service; and so on.

One of skill in the art may appreciate that a collaborative software environment, such as described herein, along with its respective services, functions, and operations, can be implemented in a number of suitable ways to conform to a number of open or closed source protocols (e.g., version control protocols, messaging protocols, and so on) or techniques and, as such, it is understood that as used herein the phrase “collaborative software environment” refers to any and all software platforms and systems, whether centralized or distributed and whether implemented with a client-server architecture, a serverless architecture, an event-driven architecture, or any suitable combination thereof.

As noted above, for simplicity of illustration and description, the embodiments described herein reference an example collaborative software environment including an issue tracking service, but it may be appreciated that this is merely one example service that can be provided by a collaborative software environment and in other constructions and architectures, different and/or additional services may be provided by such an environment and may leverage methods and systems described herein.

An “issue tracking service,” as described herein, is a project management system or tool that can be implemented in whole or in part as software executed by a virtual, containerized, or physical server or other computing appliance or combination of appliances that provides a team of individuals with a means for communicating and exchanging information with one another.

In many examples, an issue tracking service is configured for use by a software development team to exchange information that can facilitate the completion and assignment of discrete tasks related to software development projects from creation of new user stories (i.e., user-perspective feature requests or desired functionality), through proof of concept testing, through integration testing, through release of software to one or more users, and through reporting and fixing of software errors or inefficiencies (“bugs”).

In many examples, an issue tracking service, however configured or used by a team of individuals or an organization, is implemented with a client-server architecture in which a host server or service of the issue tracking service exchanges requests and responses (which may comply with a communication protocol such as HTTP, TCP, UDP, and the like), with one or more clients. In other cases, event-driven architectures may be used. In this manner, a host server of an issue tracking service can serve information to each client, and in response, each client can render a graphical user interface on a display to present that information to the user (e.g., a developer) of that respective client.

Although it may be appreciated that an issue tracking service can be configured in many ways and/or can be leveraged by a number of different teams for a number of different purposes, including non-software purposes, for simplicity of description the embodiments described herein reference an issue tracking service configured for use by a software development team as a portion of a suite of software tools or services typically referred to as collaborative software environment. In these constructions, the issue tracking service can be configured to receive from clients one or more “issue reports” that contain information describing a task to improve the performance or function of a particular software application.

An issue report may capture user stories, epics, user interface improvements, designs, or other non-functional tasks (herein, “features” or “feature requests”). In other cases, an issue report can capture information related to unintended behaviors of a given software product, typically referred to as a “bug.” For simplicity of description, the embodiments that follow reference an issue tracking service configured for use by a software development team primarily to track bugs discovered in existing software products.

As noted above, an issue tracking system or service typically includes a backend and a frontend. More specifically, a client application (e.g., the frontend) is configured to communicably couple to a server application (e.g., the backend).

The client application may be defined by executable code stored in a memory of, and executed by a processor of, a client device. In particular, as noted with respect to other embodiments described herein, a client device may be supported by one or more virtual or physical hardware devices, referred to herein as resource allocations, that may be leveraged to perform, coordinate, or otherwise instantiate one or more services or functions of the client device.

For example, a client device as described herein can include a processor allocation, a memory allocation, and/or a network connection allocation that can be leveraged to instantiate the client application. In particular, the client application can be defined by executable code and/or binary code stored in a persistent memory allocation.

A processor allocation can be configured to access the persistent memory allocation to retrieve the executable instructions and/or binary code and can be configured to load at least a portion thereof into a working memory allocation. With the support and assistance of the memory allocation, the processor allocation can instantiate the client application (in some examples, over an operating system) to facilitate interaction with, and use of the client application by, an end-user.

Similarly, the server application (also referred to as a host service) may be defined by executable code stored in a memory of, and executed by a processor of, a host device or service. In particular, as noted with respect to other embodiments described herein, a host device may be supported by one or more virtual or physical hardware devices (co-located or geographically distributed), referred to herein as resource allocations, that may be leveraged to perform, coordinate, or otherwise instantiate one or more services or functions of the host device.

For example, a host device as described herein can include a processor allocation, a memory allocation, and/or a network connection allocation that can be leveraged to instantiate the server application. In particular, as with the client application, the server application can be defined by executable code and/or binary code stored in a persistent memory allocation.

A processor allocation can be configured to access the persistent memory allocation to retrieve the executable instructions and/or binary code and can be configured to load at least a portion thereof into a working memory allocation. With the support and assistance of the memory allocation, the processor allocation can instantiate the server application (in some examples, over an operating system) to facilitate interaction with, and use of the issue tracking system by one or more instances of the client application.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first- or third-party APIs, local or remote databases (whether relational, NoSQL, or other architectures, or a combination thereof), programming languages, software design techniques (e.g., procedural, asynchronous, event-driven, and so on or any combination thereof), and so on.

The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways, several of which are described below.

In view of the foregoing, it may be appreciated that generally and broadly, since many different types of tools or applications are used for different purposes and at different stages of the lifecycle of project management, making a document or an object of another application available from or within an issue tracking system may result in increased efficiency, productivity, and/or convenience for a user. The present disclosure describes various embodiments to make data or information from other applications or services visible and interactable from, or within, the issue tracking system.

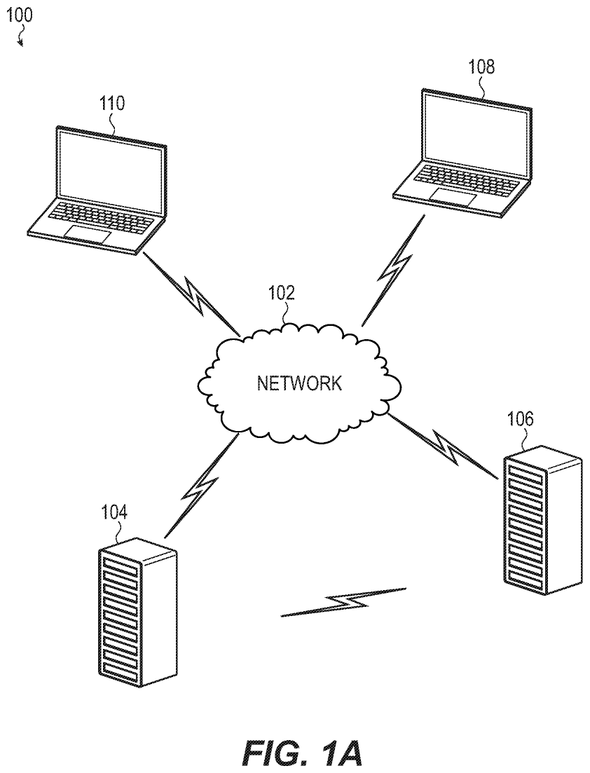

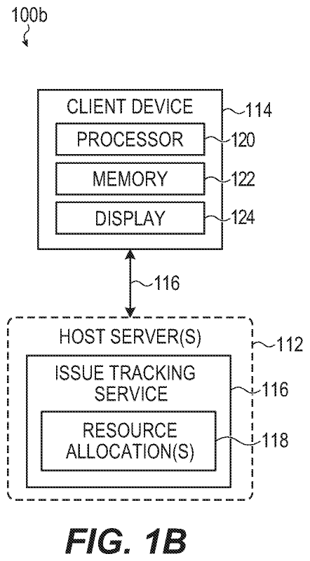

These foregoing and other embodiments are discussed below with reference to FIGS. 1A-6. However, those skilled in the art will readily appreciate that the detailed description given herein with respect to these figures is for explanation only and should not be construed as limiting.

FIG. 1A is a diagram depicting a networked environment in which various embodiments of the present disclosure may be implemented. As shown in FIG. 1A, an example network environment including a network 102 may include one or more host services supporting one or more software platforms, such as a first platform 104, a second platform 106, one or more users of those software platforms and accessing those platforms via one or more client devices, such as a client device 108 or a client device 110. The software platforms 104, 106, and the client devices 108, 110 may be communicatively coupled with each other over the network 102, which may be a private and/or public network. Phrased in a different manner, the network 102 may enable the software platforms 104, 106, and the client devices 108, 110 to communicate with each other and to exchange information.

The first platform 104 and second platform 106 may each be a virtual or physical server, which may host one or more applications. For example, the first platform 104 may be host to an issue tracking system. In particular, the first platform 104 may include an instance of software (a backend application), supported by a processor allocation and a memory allocation, that provides backend functionality supporting an issue tracking system as described herein.

The backend of the issue tracking system on first platform 104 may receive a request from a client application providing frontend functionality for the issue tracking system, over a processor allocation and memory allocation of the client device 108. The issue tracking system on the first platform 104 may process the received request from the client device 108 and generate a response to send to the client device 108.

The second platform 106 may be host to a separate application, such as a code repository application. In particular, the second platform 106 may—like the first platform 104—include an instance of software (a backend application), supported by a processor allocation and a memory allocation, that provides backend functionality supporting the code repository system.

In this example, the second platform 106 can be configured to report periodic messages—via the network or via a direct communication channel—to the first platform 104 such that individual tickets stored by the first platform 104 can be, as requested by a user, rendered in a graphical user interface of the client device 108 or the client device 110 alongside information (or other information or data or external links) that otherwise is internal to the second platform 106. As described above, this architecture substantially reduces context switching for users of the client devices 108, 110.

In many embodiments described herein, messages and information communicated from a software platform (such as the second platform 106) to an issue tracking system as described herein can be referred to as “external system data fragments” and/or “objects” of, or sent by, a remote computing system. These objects, and/or data extracted therefrom or metadata thereof can be displayed by the issue tracking system within frontend graphical user interfaces of the issue tracking system, such as on a graphical user interface of the client devices 108, 110.

For example, in one embodiment, the second platform 106 can host one or more log files associated with a particular bug or issue tracked by the first platform 104. In these examples, the first platform 104 can receive from the second platform 106 a message that identifies one or more issues (e.g., by ID) stored by the first platform 104 and/or a query that may result in the first platform 104 identifying one or more issues. As described with respect to other embodiments described herein, the message can also include a link or URL to a location or API endpoint of the second platform 106. Once the message is received by the first platform 104, and at least one issue report is identified (e.g., by query or by ID), a link to the logfile at the second platform 106 can be displayed alongside information about the associated issues whenever a client device, such as the client devices 108, 110, requests the first platform 104 to view one of those issues. More simply, a user of the client device 108 can make a request to view issue 123 of the first platform 104. The first platform 104, having received a message regarding issue 123 from the second platform 106, can cause the client device 108 to render a graphical user interface including information about issue 123 (e.g., issue title, assignee, deadline, assigned date, description, and so on) alongside a convenient URL to one or more logs stored at the second platform 106. In some cases, a snippet of the logs (or other graphical or text preview) can be generated by the first platform 104, the second platform 106, and/or the client device 108 so that a user of the client device 108 can be presented with a preview prior to clicking through the link to access the log files at the second platform 106.

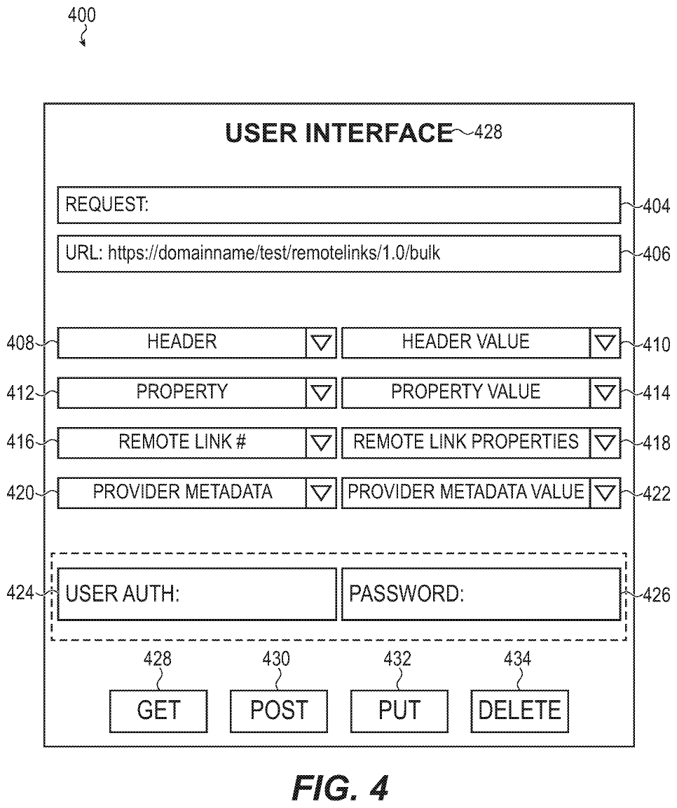

In other embodiments, the client device 110 may integrate a logfile from the customer site using a webservice, a remote procedure call, and so on. The logfile is thus an object of another application that may be useful to be integrated in the issue tracking system as an external system data fragment displayed in a frontend graphical user interface of the issue tracking system/first platform 104. The object may be integrated in the issue tracking system using the webservice, which may be implemented, for example, using service-oriented architecture protocol (SOAP) and/or representational state transfer (REST). The webservice may be implemented using any programming language, such as, C, C++, Java, Perl, Python, and so on. The client device 110 may generate the webservice request using a user interface described using FIG. 4 below to integrate the object as an external system data fragment in the issue tracking system. Additionally, or alternatively, a command like Client URL (cURL) may be used to generate a webservice request to integrate the object as an external system data fragment in one or more graphical user interfaces of the first platform 104.

The webservice request generated from the client device 110 may be authenticated prior to updating the issue with the object received in the webservice request. In other embodiments, the webservice request may be authenticated to validate whether the client device has permissions to update the issue on the issue tracking system. In some cases, the client device may be granted permissions to update a list of only specific issues identified based on issue IDs.

In some cases, an application to which an object refers may be validated or authenticated (e.g., source authentication) before updating an associated issue in an issue tracking system such as the first platform 104.

For example, an object that is the subject of a message received at an issue tracking system as described herein may be served from an application, which may not have been approved for use due to an information security concern. If the object has been found to be associated with a non-approved application, then the request from the client device to integrate the object as an external system data fragment in the issue tracking system may be rejected or silently ignored.

In other embodiments, an authentication and/or authorization operation may be performed based on userID and password (and/or hashes or other auth data derived therefrom or associated therewith) included in the webservice request.

An authentication and/or authorization operation may also be performed using a token—or more than one token—included in the webservice request. A token may be a JSON Web Token (JWT), or an OAuth based token. The token may be generated by an API token generation function hosted by a collaboration tool as described herein. In other cases, the token may be a tenant-specific token, a role-specific token, or any other suitable token. In some cases, an authentication and/or authorization operation may be based on a digital certificate installed on a client device used by the client device 110.

Accordingly, as described above, from an instance of an application running on a client device of the client device 110, a webservice request, which may also be referred to as an API call, may be received at the second platform 106. The second platform 106 may send the received webservice request (and/or a second webservice request based at least in part on the first webservice request and/or information within the first webservice request) to the first platform 104, which hosts the issue tracking system, as mentioned above.

The issue tracking system on the first platform 104 may then authenticate the source of the API call. In other embodiments, the source of the API call may be a user, such as the client device 110, and/or an application associated with the object being integrated in the issue tracking system as an external system data fragment.

In some embodiments, if authentication of the source of the API call is successful, a permissions level associated with a user or role of the API call may be determined. In other words, if it is determined that the user and/or the application to which the object to be integrated in the issue tracking system as an external system data fragment is authorized, then the relevant permissions level may be assessed by the issue tracking system on the first platform 104.

In other embodiments, a permissions level set for the client device 110 may allow the user to integrate an object of only certain categories. In some cases, the client device 110 may be allowed to integrate an object in the issue tracking system for only a list of specific issues.

In some cases, the client device 110 may have permission to access and view only a portion of information related to an issue to which the object is being integrated as an external system data fragment. Accordingly, based on a permissions level associated with the user, the object may be integrated in the issue tracking system, and/or only information for which the user has access may be displayed to the user.

Upon determining that the client device 110 has permission to integrate an object received from an external source (such as the second platform 106) in the issue tracking system, a category of the object may be determined. A category of the object may be one or more of a logfile, a document, a test, a logfile report, a report, and so on. In some cases, a category or type of the object (or an attribute thereof) may identify the object as related to security.

For example, a category attribute may identify the object as related to coverage or a scope related to the issue with which the object is being integrated as an external system data fragment. In some cases, the category may be user-defined or a user-specified category, and the user may describe the object using alphanumeric text information. The length of the alphanumeric text information may be limited, e.g., 60 characters.

As described above, the object may be received as a payload or data in the API call. Based on the category of the object being integrated as an external system data fragment, the object may be grouped with other objects of the same category that are received as external system data fragments from the same and/or another instance of the application that is running on the client device of the client device 110 or any other user.

For example, all external system data fragments of type “logfile” may be grouped together so that a user can have access to all external system data fragments of the similar type at one place.

In other embodiments, external system data fragments may not be grouped together based on category, but may be displayed in a specific order, for example, by category, by date, by name, by application required to access the object, and so on.

A category, date on which the object was created and/or last updated, name of the object, an application required to access the object, an author of the object, a user requesting the object be integrated in the issue tracking system, and so on may be represented using one or more attributes of a message or object. Each attribute may have one or more values associated with the attribute separated by a delimiter, such as a comma, a space, and so on.

In some embodiments, an issue tracking system (e.g., the first platform 104) may analyze external system data fragments to determine one or more keywords, for example, search terms that may be used to associate received external system data fragments with newly-opened issue reports, and/or other existing issue reports. In other cases, some external system data fragments that do not reference a particular issue report or set of issue reports may be analyzed to determine one or more issue reports to which the external system data fragments may relate. For example, keywords may be extracted from content of a received external system data fragment and, based on those keywords, an issue tracking system can determine one or more issues to associate with those data fragments.

These foregoing embodiments depicted in FIG. 1A and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that an issue tracking system can be implemented in a number of suitable ways. FIG. 1B is a schematic representation of an issue tracking system 100b as described herein.

The example issue tracking system 100b can be implemented with a client-server architecture including a host server 112 that communicably couples (e.g., via one or more networking or wired or wireless communication protocols) to a client device 114.

It may be appreciated that other client devices may be configured in a substantially similar manner as the client device 114, although this may not be required of all embodiments and different client devices can be configured differently and/or may transact data or information with, and/or provide input(s) to, the host server 112 in a unique or device-specific manner.

In many embodiments, the host server 112 is configured to operate within or as a virtual computing environment that is supported by one or more physical servers including one or more hardware resources such as, but not limited to (or requiring) one or more of: a processor; a memory (also referred to as a working memory); non-volatile storage (also referred to as persistent memory); networking connections; input elements; and the like.

The host server 112 can leverage such resources to instantiate a number of discrete subservices or purpose-configured modules, containers, virtual or physical networks, or virtual machines each configured to perform, coordinate, host, serve, or otherwise provide one or more services, functions, or operations of the host server 112, such as an issue tracking service 116. In one example, the issue tracking service 116 is hosted by a virtual machine or container executing over physical resources of the host server 112, identified as the resource allocations 118. It may be appreciated, however, that this is merely one example construction and that in other embodiments other issue tracking services and/or other services of a collaborative software environment can be provided.

The client device 114 can be any suitable personal or commercial electronic device and may include, without limitation or express requirement, a processor 120, volatile or non-volatile memory (identified, collectively, as the memory 122), and a display 124. Example electronic devices include, but are not limited to: laptop computers; desktop computers; cellular phones; tablet computing devices; and so on. It may be appreciated that a client device 114, such as described herein, can be implemented in any suitable manner.

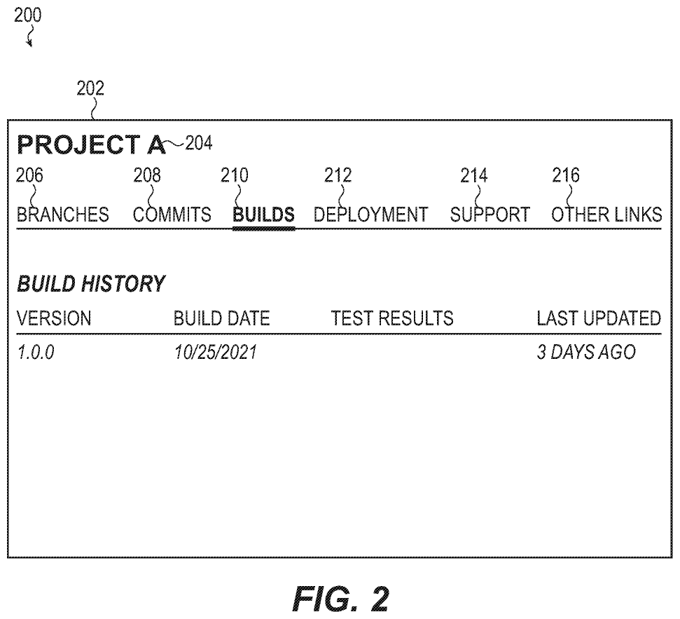

FIG. 2 is an example screen of a graphical user interface (GUI) in accordance with some embodiments of the present disclosure. The GUI screen 200 shown in FIG. 2 may be an example GUI screen of a frontend application of an issue tracking system. The issue tracking system may be running on a client device such as the client device 108 of FIG. 1A or the client device 114 of FIG. 1B.

With reference to elements of FIG. 1A, the client device 108 may send a search query using an API (e.g., REST or SOAP API) for a particular issue of a number of issues tracked using the issue tracking system on the first platform 104. More simply, the client device 108 may request to view information, on a the GUI screen 200, related to a particular issue report.

The search query from the client device 108 may be received and processed by the issue tracking system on the first platform 104, and a query response (using a REST or SOAP API, as examples) may be returned to the client device 108.

An instance of a frontend application issue tracking system running on the client device of the client device 108 may process the received query response and render a page 202 on a display of the client device GUI screen 200.

In other embodiments, the particular issue specified in the search query and the search query response may have attributes, including but not limited to, a title 204, branches 206, commits 208, builds 210, deployment 212, support 214, and/or other links 216. As shown in FIG. 2, the particular issue may be related to a software development issue, and accordingly the rendered page may include information such as software development branches where the particular issue may be required to be fixed under the branches 206.

The page 202 may also display information of any code check-in performed on any of the software branch under the commits 208. Similarly, the builds 210 may display information of a build history, including but not limited to, a version of the build, a build date of the build, test results of the build, and the last updated date for any status update for the build.

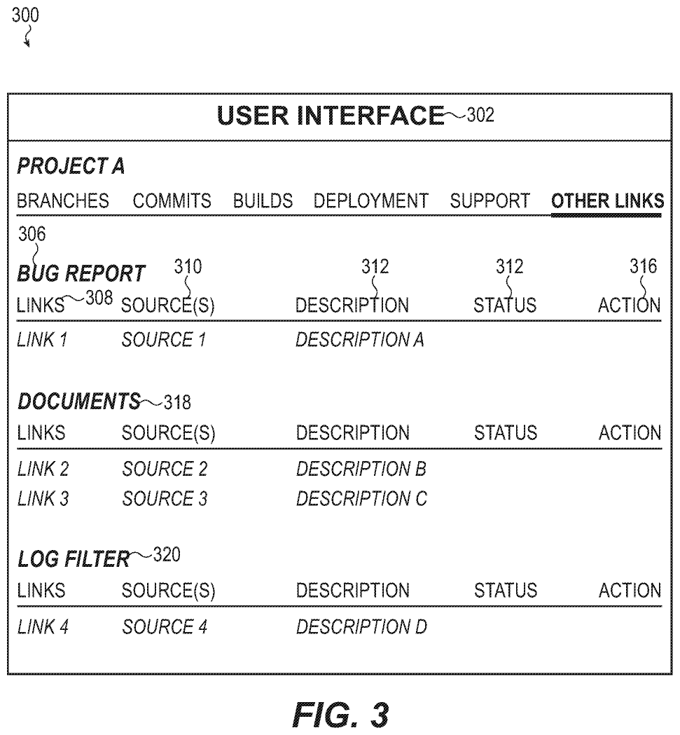

The deployment 212 and the support 214 may provide the client device 108 additional information related to deployment of, for example, the software fix of the issue on various customers' sites and any support related issues, respectively. The other links 216 may display the user objects of other applications integrated in the issue tracking system as described above. Information displayed to the client device 108 is shown in more detail using FIG. 3, as described below.

FIG. 3 is another example screen of the GUI of FIG. 2 in accordance with some embodiments. As shown in FIG. 3, a GUI screen 300 displayed on the display of the client device of the client device 108 may display a user interface 302 that shows objects from other applications integrated in the issue tracking system as external system data fragments when the user selects or clicks the other links 216.

As shown in FIG. 3, external system data fragments or objects from other applications integrated in the issue tracking system for the specific issue may be of different categories. Some of the categories of the external system data fragments are shown in FIG. 3 as bug report 306, documents 318, and a log filter 320.

As mentioned above, by way of a non-limiting example, the category of the object may be one or more of a logfile, a document, a test, a logfile report, a report, and so on. In some cases, the category of the object may identify the object as related to security. The category may identify the object as related to coverage or a scope related to the issue with which the object is being integrated as an external system data fragment.

In some cases, the category may be user-defined or a user-specified category, and the user may describe the object using alphanumeric text information. The length of the alphanumeric text information may be limited, e.g., 60 characters.

Each external system data fragment may be displayed under a links header 308 along with additional information, such as its source(s) under a source(s) header 310, its description under a description header 312, its status under a status header 314, and available action(s) to perform on the external system data fragment under an action header 316. For example, an external system data fragment LINK 1 from a source SOURCE 1 may be integrated in the issue tracking system in accordance with the embodiments described above.

Description of the external system data fragment link 1 may be shown under the description header 312. In other embodiments, the available actions for the external system data fragment may be one or more of an add, an update, a delete, an acknowledge, a review, and so on.

In the illustrated embodiment, LINK 2 and LINK 3 from sources SOURCE 2 and SOURCE 3, respectively, are shown under the category documents 318 because each of the external system data fragments LINK 2 and LINK 3 is identified of Documents category. An external system data fragment LINK 4 from a source SOURCE 4 and of a category log filter is shown separately from external system data fragments of other categories.

Even though the external system data fragments in FIG. 3 are shown grouped based on their category, the external system data fragments may be grouped based on any other criterion, such as a source, a date or creation and/or last update, a status, and so on. In yet other examples, as described above, external system data fragments may be shown in other ways, such as within custom-rendered graphical user interface elements, as aggregations of multiple external data fragments (e.g., custom status of multiple external processes or reports), as time-based charts or visualizations, and so on; these examples are not exhaustive.

FIG. 4 is an example screen of a GUI in accordance with some embodiments. A GUI screen 400 may display a user interface 402. The user interface 402 shown is for example only, and may identify a type of an API call message being generated using the user interface as Request 404 to a destination specified by a URL 406. The user of the client device may specify the destination URL and set one or more header values 410 for one or more headers 408 (e.g., Content-Type, Accept) of the API call to the issue tracking system on the first platform 104. Similarly, one or more property or attribute values 414 may be set for one or more property or attribute 416 (e.g., accountID, projectID) of the API call.

The user interface 402 may allow the user to integrate more than one object or external system data fragment in a single API call. Accordingly, the user may set external system data fragment properties 418 for each external system data fragment 416. In other embodiments, external system data fragment properties may include, but are not limited to, a display name, a category, a description, a date of creation, a date of last update, a current status of the external system data fragment (e.g., InProgress, complete, abandoned, published), and so on.

The user interface may allow the user to set provider information using one or more provider metadata headers 420 and its corresponding value set using provider metadata value 422. As described above, for example, the user may provide keywords using the provider metadata headers 420 and provider metadata values 422.

A user may also be required to include information for authentication of the API call in the API call request. The user may provide User Authorization (e.g., userID) 424 and user password 426 for authentication of the API call. The userID and user password may also be used for determining permissions level for the given user. The user may select a particular command for the API call as shown in FIG. 4 as GET 428, POST 430, PUT 432, and DELETE 434.

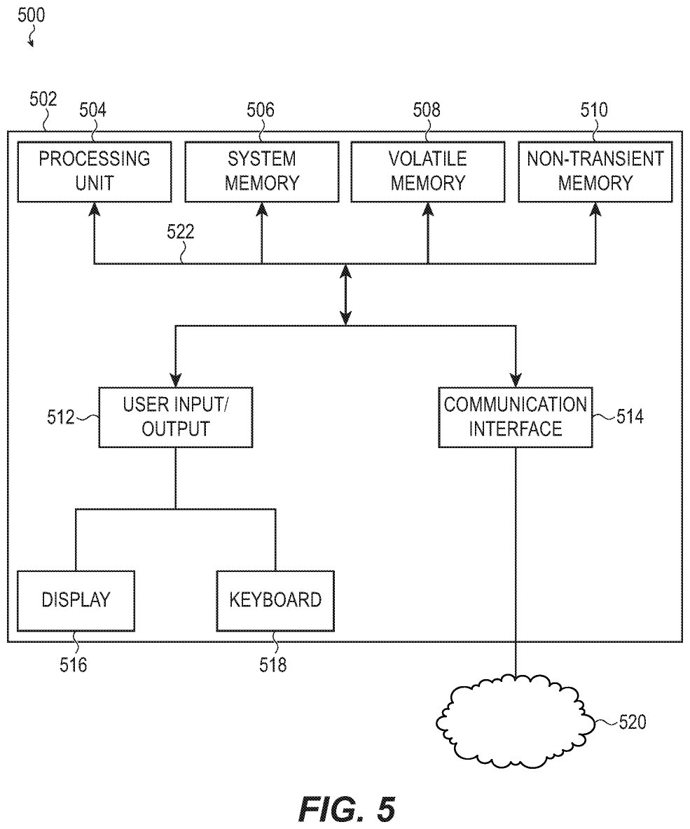

FIG. 5 is a block diagram of a computerized system implementing various embodiments of the present disclosure. FIG. 5 provides a block diagram of a computer processing system 500 configurable to implement embodiments and/or features described herein. System 500 may be a general-purpose computer processing system.

It will be appreciated that FIG. 5 does not illustrate all functional or physical components of a computer processing system. For example, no power supply or power supply interface has been depicted, however system 500 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 500 includes at least one processing unit 502. The processing unit 502 may be a single computer processing device (e.g., a central processing unit, graphics processing unit, or other computational device), or may include a plurality of computer processing devices. In some instances, where a computer processing system 500 is described as performing an operation or function, all processing required to perform that operation or function will be performed by processing unit 502. In other instances, processing required to perform that operation or function may also be performed by remote processing devices accessible to and useable by (either in a shared or dedicated manner) system 500.

Through a communications bus 522, the processing unit 502 may communicate with one or more machine readable storage (memory) devices which store computer readable instructions and/or data which are executed by the processing unit 502 to control operation of the processing system 500. In this example, system 500 may include a system memory 506 (e.g., a BIOS), volatile memory 508 (e.g., random access memory such as one or more DRAM modules), and non-transient memory 510 (e.g., one or more hard disk or solid-state drives).

The system 500 also includes one or more interfaces via which the system 500 may interface with various devices and/or networks. Other devices may be integral with system 500 or may be separate. Where a device is separate from system 500, connection between the device and system 500 may be via wired or wireless hardware and communication protocols and may be a direct or an indirect (e.g., networked) connection.

Wired connection with other devices and/or networks may be by any appropriate standard or proprietary hardware and connectivity protocols. For example, the system 500 may be configured for wired connection with other devices/communications networks.

Wireless connection with other devices/networks may similarly be by any appropriate standard or proprietary hardware and communications protocols. For example, the system 500 may be configured for wireless connection with other devices/communications networks using one or more of: Bluetooth; WiFi; near field communications (NFC); Global System for Mobile Communications (GSM), and/or other wireless connections.

Generally speaking, and depending on the particular system in question, devices to which the system 500 connects—whether by wired or wireless means—include one or more input devices, such as a keyboard 518, to allow data to be input into/received by the system 500 and one or more output devices, such as a display 516, to allow data to be output by the system 500. Example devices are described below; however, it will be appreciated that not all computer processing systems will include all mentioned devices, and that additional and alternative devices to those mentioned may well be used.

For example, the system 500 may include or connect to one or more input devices by which information/data is input into (received by) the system 500.

In other embodiments, where the system 500 is a client device such as the client device 108 or the client device 110, it may include a display 516 (for example, a touch screen display), a camera device, a microphone device (which, for example, may be integrated with the camera device), a cursor control device (e.g., a mouse, trackpad, or other cursor control device), a keyboard, and a speaker device.

The system 500 may also include one or more communications interfaces 514 for communication with a network 520, such as the network 102 of the environment 100. Via the communications interface(s) 514, the system 500 can communicate data to and receive data from networked systems and/or devices.

The system 500 may be any suitable computer processing system, for example, a server computer system, a desktop computer, a laptop computer, a netbook computer, a tablet computing device, a mobile/smart phone, a personal digital assistant, or an alternative computer processing system.

The system 500 stores or has access to computer applications (also referred to as software or programs)—e.g., computer readable instructions and data, which, when executed by the processing unit 502, configure the system 500 to receive, process, and output data. Instructions and data can be stored on non-transient machine-readable medium such as 510 accessible to system 500. Instructions and data may be transmitted to/received by system 500 via a data signal in a transmission channel enabled (for example) by a wired or wireless network connection over an interface such as communications interface 514.

Typically, one application accessible to the system 500 may be an operating system application. In addition, the system 500 may store or have access to applications, which, when executed by the processing unit 502, configure the system 500 to perform various computer-implemented processing operations described herein.

In some cases, part or all of a given computer-implemented method will be performed by the system 500 itself, while in other cases processing may be performed by other devices in data communication with the system 500.

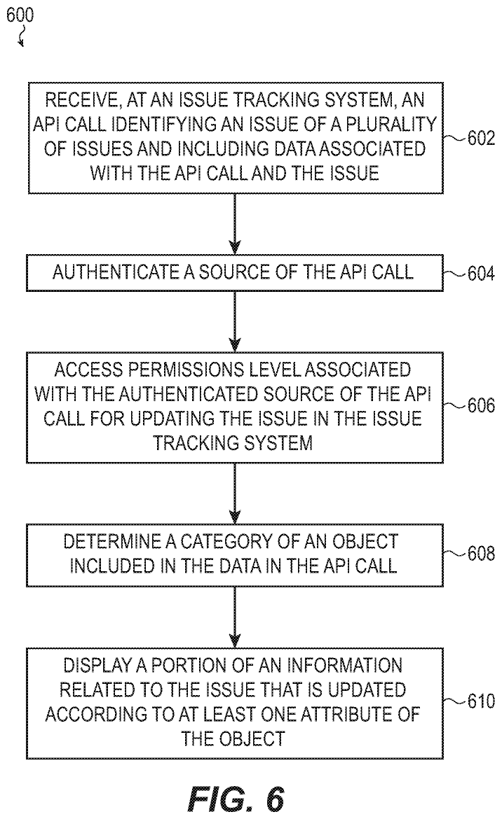

FIG. 6 is a flow chart that describes method steps in accordance with some embodiments. As shown in a flow chart 600, at 602, an API call may be received at the first platform 104 on which an issue tracking system is stored and running. The API call may be received from a client device of the client device 110 and may identify a particular issue of a plurality of issues being tracked and managed by the issue the tracking system. The issue tracking system on the first platform 104 may be configured to present information related to the issue on a graphical user interface that is described above using FIG. 2 and FIG. 3, for example. The received API call may further include an object of another application, such as a document stored in an application, and so on, for integration in the issue tracking system.

At 604, the received API call may be processed by the issue tracking system on first platform 104 for authenticating the source of the API call before further processing of the data or payload integrating an object of another application in the issue tracking system. The authentication may be performed using a user identification and user password included in one or more headers of the API call and/or in data of the API call. The authentication may also be performed based on a JSON web token or an OAuth token included in the API call. In some cases, the authentication of the source of the API call may be performed using a digital certificate installed on a client device from where the API call is made. In some cases, in addition to the authentication of the user making the API call, the authentication may also include validating the application associated with the object is permitted for that object to be integrated as an external system data fragment in the issue tracking system.

At 606, a permissions level associated with the authenticated source of the API call may be assessed. The permissions level associated with the authenticated source of the API call may be stored in a database, which may or may not be at the first platform 104. In accordance with the assessed permissions level and authentication of the source of the API call, at 608, a category of the object in the data or payload of the API call may be determined. The category of the object may be used to determine grouping of the object with other such objects of one or more applications different from the issue tracking system. Based on the determined category, the issue specified in the API call may be updated to include the object as an external system data fragment.

At 610, information of the updated issue may be displayed to a user, for example, the client device 108, in response to an API call to display information of the updated issue. The issue may be updated in accordance with one of the attributes of the object. For example, one of the attributes of the object is category, and the information of the issue may be displayed according to grouping of the objects based on the category of the object.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A method for operating an issue tracking system configured to present information related to an issue of a plurality of issues at a graphical user interface (GUI) rendered by an instance of a frontend application of the issue tracking system, the method comprising:
receiving, at a backend instance of the issue tracking system from an external platform, an application programming interface (API) call, the API call comprising:
information identifying the issue; and
a structured data object;
authenticating, by the issue tracking system, a source of the API call based, at least in part, on the structured data object or the information identifying the issue;
determining, from an attribute of the structured data object, a type of the structured data object; and
causing to be displayed in the GUI, by the backend instance at the frontend application instance, a portion of the structured data object when the frontend application instance displays the information related to the issue.

2. The method of claim 1, wherein the structured data object comprises a status of a remote operation.

3. The method of claim 1, wherein the structured data object links to a file.

4. The method of claim 3, wherein the file comprises:
a log file;
a document; or
a multimedia file.

5. The method of claim 1, wherein the information identifying the issue further identifies at least one other issue of the plurality of issues.

6. The method of claim 1, wherein the external platform comprises a code repository system.

7. The method of claim 1, wherein the external platform is a third-party system.

8. The method of claim 1, wherein the API call traverses a public network.

9. The method of claim 1, wherein the backend instance causes to be displayed a visual indication of status of a remote process based, at least in part, on the structured data object.

10. The method of claim 1, wherein the backend instance causes to be displayed a preview of a remote file.

11. The method of claim 10, wherein the preview is generated at least in part by one of:
the frontend application instance;
the backend instance; or
the external platform.

12. A client device configured to render a graphical user interface of a frontend application supporting an issue tracking system, the client device comprising:
a display;
a memory allocation; and
a processor allocation configured to cooperate with the memory allocation to instantiate an instance of the frontend application, the frontend application configured to:
receive, from a user of the client device, an instruction to access a page associated with the issue tracking system;
submit a request to a backend application supporting the issue tracking system for the page in response to the instruction;
receive first information corresponding to the page from the backend application in response to the request;
render on the display the graphical user interface comprising the page;
receive, from the backend application, second information corresponding to a state of data stored by an external system; and
automatically updating the rendering of the page on the graphical user interface based on the second information.

13. The client device of claim 12, wherein the second information comprises a link to a remote file.

14. The client device of claim 12, wherein the second information comprises a status of a code repository.

15. The client device of claim 14, wherein the status corresponds to a result of a static analysis operation.

16. The client device of claim 15, wherein the static analysis operation corresponds to a code repository associated with the page.

17. A method for operating an issue tracking system, the method comprising:
receiving, from an external platform, a first application programming interface (API) call comprising information identifying an issue tracked by the issue tracking system;
receiving, from the external platform, a second API call comprising information associated with a status of an external system;
extracting from at least one of the first API call or the second API call an authentication token;
authenticating, by the issue tracking system, the authentication token;
extracting from the at least one of the first API call or the second API call, a type associated with the status of the external system; and
causing to be displayed in a graphical user interface associated with a frontend of the issue tracking system, the graphical user interface presenting a visual representation of the status.

18. The method of claim 17, wherein the status corresponds to a result of a static analysis operation executed against a code repository.

19. The method of claim 17, wherein the status corresponds to metadata describing a remote file.

20. The method of claim 17, wherein the visual representation is generated at least in part by one of:
a frontend application instance of the issue tracking system;
a backend application instance of the issue tracking system; or
the external platform.
